(19) United States
(12) Patent Application Publication
(10) Pub. No.: US 2005/0257818 A1
(43) Pub. Date: Nov. 24, 2005

(54) Walking cane

(76) Inventor: Hank C. Gillebaard, Laguna Beach, CA (US)

Correspondence Address: STETINA BRUNDA GARRED & BRUCKER, 75 ENTERPRISE, SUITE 250, ALISO VIEJO, CA, 92656, US

(21) Appl. No.: 10/848,847

(22) Filed: May 19, 2004

(51) Int. Cl. A45B 3/00; A45B 5/00; A61H 3/02

(52) U.S. Cl. 135/72

(57) ABSTRACT

A walking cane comprising a handle and a shaft is provided. The shaft defines a handle end portion which may be castellated. And, the handle defines an aperture wherein the aperture may have a conical shape. The handle end portion and the aperture may be sized and configured such that the handle end portion is frictionally engageable to an inner surface of the aperture. In this regard, a single handle may be associated with a shaft selected from a plurality of shafts. In other words, the handle and shaft are removeably engageable with respect to each other such that variously styled shafts are interchangeable with the handle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to a walking cane, and more particularly to a walking cane having a handle that is removeably engageable with a shaft. The handle may be aesthetically decorated, and ergonomically designed to relieve pain at a user's wrist. The shaft may be selected from a plurality of shafts wherein each shaft within the plurality of shafts may be uniquely designed to match different outfits of the user and occasions (i.e., formal and informal occasions). This enables a person to have a walking cane that may be transformed to be aesthetically coordinated with a person's outfit or occasion as well as have an ergonomically designed handle that is both aesthetically pleasing and functional so as to relieve pain at a user's wrist.

Prior art walking canes are devices that may be utilized by individuals of all ages to aid in reducing pain in the individual's leg(s) during walking. For example, if a person's leg is injured such that the injured leg is not able to bear the whole weight of the person, then the person may use prior art walking canes to reduce the pressure placed on the injured leg to thereby reduce pain in that injured leg during walking. In another example, a person who suffers from arthritis may utilize prior art walking canes to help reduce pain in the user's leg created by the arthritis. In both examples, prior art walking canes are useful to reduce pressure placed on the user's leg and to reduce any pain in the leg created by pressure on the legs. These injuries and diseases (i.e., physical conditions) are a part of people's lives of all ages, old and young, and as a result, the market for the prior art walking canes is broad.

Moreover, the prior art walking canes enable people with injured legs or people suffering from disease to enjoy a great amount of mobility and freedom. As stated above, prior art walking canes may be utilized by persons with an injured leg or arthritis. In both situations, the person may experience pain while walking, but if the pain is too great to bear and a prior art walking cane is not available, then the person may be confined to a wheel chair. In this regard, the person may be limited to places and activities designed for wheel chairs. For example, the place may have to have ramps and doors sufficiently wide for wheel chairs. And, even if a place is wheel chair compliant, the person may not be sufficiently capable of maneuvering the wheel chair in such a place. This limited ability of the person to maneuver about with the wheel chair further limits the person's mobility and freedom. In this regard, prior art walking canes which are easy to use may be an essential component of the person's life especially when confinement to a wheel chair would be an unduly burdensome limitation on the person's mobility and freedom. Simply put, prior art walking canes are an extremely useful and in most instances, may be an essential part of a person's life for the reasons stated above.

Nonetheless, prior art walking canes, although useful to reduce pain in legs and promote mobility and freedom, have typically been aesthetically unappealing so as to represent the idea of a physical handicap and old age. Moreover, prior art walking canes cause pain in a wrist of the user and have not been ergonomically designed to relieve such pain. With respect to the aesthetic problem in the prior art walking canes, manufacturers and designers in an attempt to create more aesthetically pleasing walking canes have decorated the handle and shaft, created uniquely shaped handles, and so forth. For example, designers have created various shaped handles such as the classic J-handle, fritz-handle, derby, and an anatomically correct handle. Moreover, designers have created handles with intricate patterns to create a more aesthetically pleasing walking cane. Even with these aesthetic enhancements, prior art walking canes may still represent the idea of a physical handicap and old age.

One reason that the prior art walking canes cannot be made to be more aesthetically beautiful is that prior art walking canes have a handle and shaft that are permanently attached to each other. In this regard, the person using prior art walking canes will typically have only one prior art walking cane that is suppose to match all of their outfits and occasions. For example, a single prior art walking cane will be used when the person goes out to a formal dinner as well as to see a movie with friends even though a more stylistic cane may be required for the formal dinner occasion compared to the movie occasion and a more stylistic cane would be inappropriate for the informal occasion. In this regard, a single cane cannot match every occasion or outfit of the person. A possible solution is to store numerous prior art walking canes for different occasions. In this instance, the person may own one prior art walking cane for formal occasions such as the formal dinner, and the person may own a different prior art walking cane for informal occasions such as the movie situation. The drawback of this solution is that the numerous prior art walking canes must be purchased and stored with each cane consuming valuable space.

With respect to the ergonomic problem in prior art walking canes, as stated above, prior art walking canes reduce the pressure applied to injured legs or legs that suffer from arthritis. However, the weight of the person is shifted from the legs to the wrist of the person. In this regard, although prior art walking canes may reduce pain in the legs, the prior art walking canes may create pain in the wrist of the user. The reason for the pain in the wrist is that 1) the weight of the person is transferred from the legs to the wrist of the user and 2) the handle is not ergonomically designed to relieve stress at the wrist of the user. For example, the classic J handle has an elongate curved bar. This handle is not ergonomically designed in that the handle creates a concentrated line of pressure across the palm of the hand. Accordingly, the pressure may translate to the wrist of the user to cause pain in the wrist.

Accordingly, there is a need in the art for an improved walking cane that is aesthetically pleasing so that the walking cane does not represent old age or physical disability and may be coordinated with the user's outfit and different occasions. Moreover, there is a need in the art for a walking cane that is ergonomically designed so as to be effective in relieving pain in the wrist of the user of the walking cane.

### BRIEF SUMMARY OF THE INVENTION

The needs identified above have been addressed by the present invention by providing a walking cane having a handle and shaft wherein the handle is removeably engageable to the shaft. The handle may be designed to resemble a lady bug, and a shaft selected from a plurality of shafts may be removeably engageable to the handle. Moreover, each one of the plurality of shafts may be designed and decorated so as to match a user's outfit or a particular occasion. For example, one of the plurality of shafts may be colored with a conservative color for a business occasion (i.e., business shaft), and in contrast, another one of the plurality of shafts may be colored with more bright and lively colors for a movie night (i.e., fun time shaft). Accordingly, if a handle is already engaged to a business shaft, then the business shaft may be removed and a fun time shaft may be engaged to the handle. This enables the user to interchange various shafts to coordinate the walking cane with the user's outfit and the occasion.

The removeable engageable feature of the walking cane of the present invention may be accomplished by providing a shaft that is removeably engageable with a collar of the handle. More particularly, the shaft may be removeably engageable with an aperture formed in the collar of the handle. The aperture may have a conical shape. And, the shaft may define a handle end portion wherein the handle end portion is formed with a castellation. In this regard, the handle end portion may be inserted into the aperture so as to create a frictional engagement between the handle end portion and the aperture; and, the handle end portion may also be subsequently removed from the aperture. Accordingly, a single handle may be associated with a plurality of different shafts. More particularly, a single handle may be engaged to a shaft selected from a plurality of different colored or styled shafts. Hence, the user of the walking cane may associate an appropriately styled or colored shaft to the handle to coordinate the style of the walking cane with the user's outfit or the occasion.

The needs identified above have also been addressed by providing a walking cane with an ergonomically designed handle with respect to both 1) a contact surface of an upper surface of the handle as well as 2) an indentation formed on a bottom surface of the handle. These ergonomic features of the handle of the present invention may be operative to reduce pain at the user's wrist and to assist the user in gripping the walking cane of the present invention.

In particular, the handle may define an upper surface, and the upper surface may further define the contact surface. The contact surface may have a curved configuration, and more particularly, the contact surface may have a semi circular or semi elliptical configuration. In relation to the curved configuration, a radius along a longitudinal direction of the contact surface may have a greater radius compared to a radius along its lateral direction. Moreover, the radiuses of the curved configuration may be equal to or less than a radius of a palm curvature of an average adult. In this regard, the ergonomically curved configuration may be operative to evenly distributed pressure to the palm of the hand of the user to thereby reduce the pressure translated to the wrist of the person and any pain in the wrist caused by the translated pressure.

The handle may further be ergonomically designed with an indentation on a bottom surface of the handle. The indentation may operate to assist the user to have a firm grip on the walking cane. More particularly, the indentation formed on the bottom surface of the handle may be sized and configured to receive at least one digit of the hand of the user. Preferably, the indentation is sized and configured to receive at least three digits of the hand of the user. The indentation may be positioned about a perimeter of the bottom surface, or in the alternative, the indentation may start at a central portion of the bottom surface and terminate at the perimeter of the bottom surface.

The ergonomics of the walking cane of the present invention is further enhanced by fabricating the shaft from a carbon fiber composite material due to its light weight and durable characteristics. To further enhance the light weight characteristic of the walking cane, the shaft may have a hollow interior. In addition to the shaft being fabricated from a carbon fiber composite material, the handle may be fabricated from a carbon fiber composite material.

The features and aspects of the present invention discussed above as well as in this specification produce a walking cane that is both aesthetically pleasing such that the walking cane may be coordinated with the user's outfit and the occasion, versatile, as well as functional to reduce pain at the wrist of the user.

### BRIEF DESCRIPTION OF THE DRAWINGS

An illustrative and presently preferred embodiment of the invention is shown in the accompanying drawings in which:

FIG. 1 is side view of a walking cane having a handle that is removeably engageable with a shaft;

FIG. 2 is a side view of the walking cane being held by a hand wherein the shaft is engaged to the handle;

FIG. 3 is a top view of a handle end portion of the shaft wherein the shaft has been castellated;

FIG. 4 is a top view of the handle illustrating a lateral groove that is bifurcated by a longitudinal groove;

FIG. 5 is a front view of the cane illustrating an inverted V shape of a front lip; and

FIG. 6 is a bottom view of the cane illustrating an indentation formed on a bottom surface of the handle.

### DETAILED DESCRIPTION OF THE INVENTION

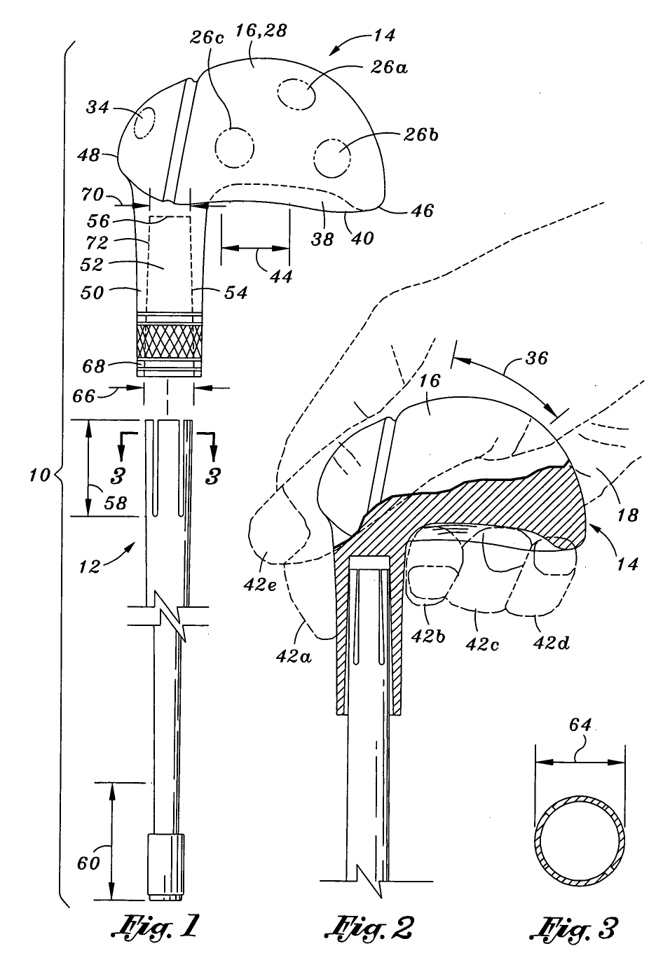

Referring now to the drawings, namely FIGS. 1-6, wherein the showings are for the purposes of illustrating the preferred embodiments of the present invention only, and not for the purposes of limiting the same, FIG. 1 illustrates a walking cane 10 which may be one aspect of the present invention, and more particularly, a shaft 12 that is removably engageable with a handle 14. To illustrate that the showings are merely for the purposes of illustrating the preferred embodiments of the present invention only, in an alternate embodiment of the present invention, it is contemplated that the shaft 12 of the walking cane 10 may be fabricated to be permanently engaged to the handle 14. With this basic understanding, the walking cane 10 which may be an aspect of the present invention shall be discussed.

As stated above, the walking cane 10 of the present invention may comprise the handle 14 and the shaft 12, as shown in FIGS. 1 and 2. The handle 14 may define an upper surface 16. And, more particularly, the upper surface 16 of the handle 14 may be sized and configured to receive a palm 18 of a hand, as shown in FIG. 2. In this regard, the upper surface 18 may have a curved configuration. And, more particularly, the upper surface 16 may have a semi-spherical configuration or semi-elliptical configuration, and as will be discussed further below, in this regard, the walking cane of the present invention is ergonomically designed to reduce pain at the user's wrist.

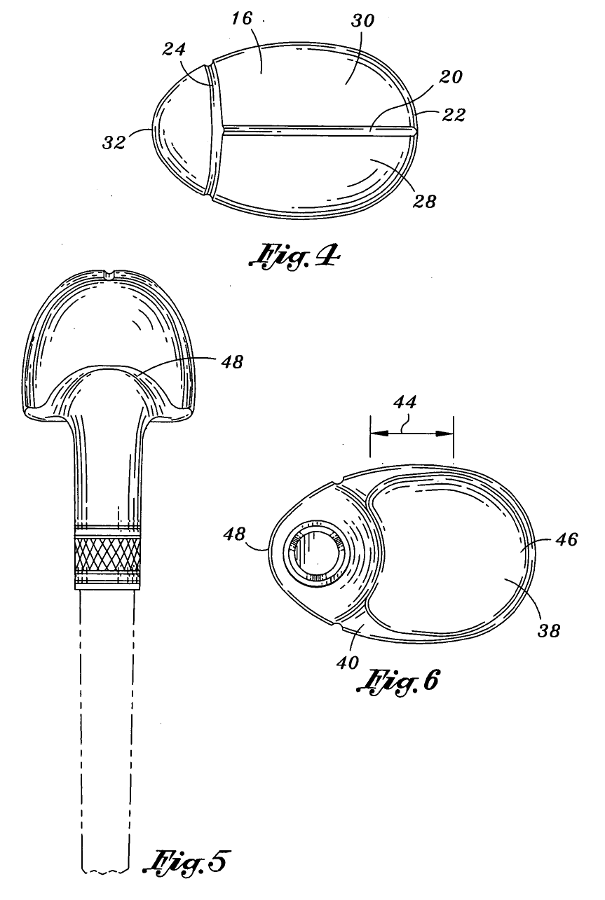

As shown in FIG. 4, the upper surface 16 may have a longitudinal groove 20 that extends from a rear portion 22 of the upper surface 16 to two thirds of the longitudinal length of the upper surface 16. The upper surface 16 may further have a lateral groove 24 that extends transversely in relation to the longitudinal groove 20. The longitudinal and lateral grooves 20, 24 may be formed on the upper surface 16 such that the longitudinal groove 20 intersects the midpoint of the lateral groove 24. The longitudinal and lateral grooves 20, 24 may be formed on the upper surface 16 such that the upper surface 16 may resemble the shell of a lady bug.

The upper surface 16 may have round indentations 26 with a flat bottom (not shown in FIG. 4 but shown in FIG. 1). For example, as shown in FIG. 1, a left side 28 of the upper surface 16 may have three round indentations 26a, b, c. Furthermore, although not shown, a right side 30 (see FIG. 4) of the upper surface 16 may have three round indentations 26. A front portion 32 of the upper surface 16 may have two crystals 34 embedded therein with one crystal embedded in the left side (shown in FIG. 1) and one crystal embedded in the right side of the front portion 32 of the upper surface (not shown). The round indentations 26 and the grooves 20, 24 may be operative to provide a beautifully decorated handle but also may have an effect of increasing the coefficient of friction between the user's hand and the upper surface 16 compared to the coefficient of friction therebetween without the rounded indentations 26 and grooves 20, 24.

The upper surface 16 may further be colored. By way of example and not limitations, the upper surface 16 may be colored with a black color, red color, white color or combinations thereof. In particular, the longitudinal and lateral grooves 20, 24 may be colored with a black color. The round indentations 26 and the front portion 32 of the upper surface 16 may be colored with a black color. The black color on the front portion 32 may be contrasted with the crystals 34 embedded in the front portion. The remaining portions of the upper surface 16 may be colored with a red color. In this regard, the upper surface 16 of the handle 14 may resemble a lady bug yet be effective in functioning as the handle 14 for the walking cane 10. Moreover, even with these beautiful decorations, the handle may be effective to reduce the pain at the user's wrist. Simply put, the walking cane of the present invention combines functionality and aesthetics without comprising either its functionality or aesthetics.

The upper surface 16 of the handle 14 may further define a contact surface 36. The contact surface 36 may be defined as the area of the upper surface 16 which contacts the palm 18 of the hand of a user during use of the walking cane 10. The contact surface 36 may be curved, and more particularly, may have a semi-spherical configuration or a semi elliptical configuration. A radius of the curved contact surface 36 in its longitudinal direction may be greater than a radius of the curved contact surface 36 in its lateral direction. Moreover, the radiuses of the curved contact surface 36 in both its longitudinal and lateral directions may be less than or equal to the radius of a palm curvature of an average adult (e.g., male, female and/or male and female). In this regard, the contact surface 36 may be ergonomically designed to distribute a weight of the user over the entire contact surface 36. Accordingly, the pressure between the walking cane, specifically, the contact surface 36 and the palm 18 of the user may be evenly distributed such that high pressure points may not develop therebetween and pain at the user's wrist may be reduced.

The ergonomic design of the handle 14 may be expressed in the upper surface 16 and more particularly, the contact surface 36, as discussed above. In particular, the ergonomic design of the handle 14 may be expressed in the relationship between the radiuses of the curved configuration of the contact surface 36 both in its longitudinal and lateral directions as well as the relationship between the radiuses of the curved configuration of the contact surface 36 and the palm curvature of the average adult. In addition to the ergonomic design of the upper surface 16 (and corresponding contact surface 36), the handle 14 is aesthetically designed with the grooves 20, 24, rounded indentations 36, and coordinated colors such that the upper surface 16 of the handle 14 resembles a lady bug. Hence, even though the handle 14 is ergonomically designed to reduce pain at the user's wrist, the handle 14 is still aesthetically pleasing such that the handle 14 of the present invention combines aesthetics and functionality in one handle 14 which prior art walking canes were not capable of accomplishing.

The handle 14 may further have a digit indentation 38 (see FIGS. 1 and 6). The term “digit” 42 refers to fingers 42a, b, c, and d and thumbs 42e of a human hand. The digit indentation 38 may be formed on a bottom surface 40 of the handle 14. The digit indentation 38 may be sized, configured, and positioned so as to receive at least one digit 42 (i.e., fingers and thumbs) of the hand. As shown in FIG. 2, by way of example and not limitation, the indentation 38 may be sized to receive three digits 42b, c, and d of the hand. The digit indentation 38 may start at a central portion 44 (see FIGS. 1 and 6) of the bottom surface 40 and extend to an outer perimeter 46 (see FIGS. 1 and 6) of the bottom surface 40. In use, the digit indentation 38 may be effective to lift the walking cane 10 from the ground as the user walks with the walking cane 10. More particularly, in use, as the walking cane 10 is pushed on the ground, the contact surface 36 applies upward pressure to the palm 18 of the hand so as to reduce a weight which the legs of the user must bear during normal walking. During the user's next stride, at least one digit 42 of the hand may be inserted into the digit indentation 38 so as to lift the walking cane 10 from the ground. In this regard, the digit indentation 38 is in an opposed relationship with the contact surface 36 and provides the user with the ability to grip the cane 10 without the cane 10 slipping away from the user. It is also contemplated within the scope of the present invention that the digit indentation 38 formed on the bottom surface 40 of the handle 14 may be positioned about at least a portion of an outer perimeter 46 of the bottom surface 40.

The handle 14 may further have a front lip 48, as shown in FIGS. 1, 5, and 6. The front lip 48 may extend across the front portion 32 of the upper surface 16. The front lip 48 may be defined where the upper surface 16 and the bottom surface 40 coincides. The front lip 48 may have an inverted V configuration, as shown in FIG. 5. The front lip 48 may be sized, configured and positioned such that the front lip 48 may engage a digit 42 of the hand of the user during use of the walking cane. In particular, by way of example and not limitation, if the indentation receives the 3^{rd} to 5^{th} digits 42a, b, and c, then the front lip 48 may receive the second digit 42a of the user's hand, as shown in FIG. 2.

The handle 14 may further have a collar 50, as shown in FIG. 1. The collar 50 may be permanently affixed to the bottom surface 40 of the handle 16. As shown in FIGS. 1 and 2, the collar 50 and handle 14 may be fabricated from a unitary material. The collar 50 may be elongate and have a cylindrical outer configuration. From a bottom side of the collar 50, an aperture 52 may be formed. The aperture 52 may define an inner surface 54 having a circular tube-like configuration with a flat bottom 56. The inner surface 54 may have a conical configuration, as shown in FIGS. 1 and 2. In this regard, a cross-sectional view of the inner surface 54 may resemble an inverted bucket.

The handle end portion 58 may be operative to be removably engageable with the handle 14, and more particularly, the inner surface 54 of the collar aperture 52. In this regard, the handle end portion 58 may have a friction fit with the inner surface 54 of the collar 50. For example, the handle end portion 58 of the shaft 12 may be formed with a castellation. When the shaft 12 is disengaged with the collar 50, as shown in FIG. 1, the castellation remains in its natural state. The natural state of the handle end portion 58 may be vertical, as shown in FIG. 1. Accordingly, the tips 62 of the castellation do not contact each other. The handle end portion 58 may define an outer diameter 64, as shown in FIG. 3, and this outer diameter 64 may be less than the inner diameter 66 (see FIG. 1) of a first end 68 of the aperture 52 yet larger than an inner diameter 70 of the second end 72 of the aperture 52. In this regard, the handle end portion 58 may easily be inserted into the first end 68 of the aperture 52, and as the handle end portion 58 is further inserted into the aperture 52 the castellation, and more particularly, the tips 62 of the castellation moves closer to each other due to the conical shape of the aperture 52 of the collar 50, as shown in FIGS. 1 and 2. Hence, frictional engagement occurs between the inner surface 54 of the aperture 52 and the handle end portion 58 of the shaft 12. Moreover, frictional engagement between the handle end portion 58 and the inner surface 54 improves as the walking cane 10 is in use due to the impact between the handle 14 and shaft 12 during each step of the user.

The frictional engagement between the handle end portion 58 and the aperture 52 of the collar 50 enables the handle 14 to be interchangeable with any one of a plurality of shafts 12. Accordingly, the walking cane 10 of the present invention may be aesthetically changed to fit the user's outfit or the occasion by interchanging the appropriate shaft 12 among the plurality of shafts 12 to the handle 14. Moreover, the ergonomic features incorporated into the handle 14 are maintained in the walking cane 10 of the present invention even though the walking cane 10 may be transformed from being appropriate for a formal occasion to being appropriate for an informal occasion by removing and engaging appropriate shafts.

The frictional engagement between the inner surface 54 of the aperture 52 and the handle end portion 58 may further be enhanced or increased by configuring the handle end portion 58 to have a corresponding conical shape equivalent to the conical shape of the inner surface 54 of the aperture 52 when the handle end portion 58 is inserted into the aperture 52. To this end, the handle end portion 58 may be castellated, and the tips 62 of the castellation may be moved inwardly or drawn closer together so as to emulate the handle end portion 58 being inserted into the aperture 52. Thereafter, the handle end portion 58 may be formed, machined, ground, lathed or otherwise fabricated so as to have the corresponding conical shape of the inner surface 54 of the aperture 52. Accordingly, the handle end portion 58, when the handle end portion 58 is not inserted into the aperture 52 of the collar may not have a circular configuration. Rather, the handle end portion 58 may have a semi-circular configuration formed on each tip 62 of the castellation. In this regard, the handle end portion 58 may have a rotating configuration of individual tips 62 configured with a semi circle.

The walking cane 10 discussed above may be beautifully decorated so as to enhance the attractive appearance of the cane 10. For example, as stated above, the upper surface 16 of the handle 14 may be decorated to resemble a lady bug. Moreover, the handle 14 resembling a lady bug may be further aesthetically enhanced by engaging a selected shaft 12 selected from the plurality of shafts 12 wherein each shaft of the plurality of shafts have a different color so as to enable the user to match the color of the shaft 12 with the user's outfit on different days. In contrast, in prior art walking canes, the shaft is permanently attached to the handle, and the shaft and the handle may have a black color. However, during use, the user may desire to have a red colored shaft attached to the handle to match the red colored outfit of the day. But, since the handle and shaft are permanently attached to each other, the user must use a different walking cane having a red colored shaft. This requires the user to store a plurality of different colored and styled canes 10 to match the outfit of the day. This requires a greater amount of storage space to store the plurality of walking canes 10. In contrast, the walking cane 10 of the present invention may have its handle 14 interchangeable (i.e., removeably engageable) with the selected shaft 12 from the plurality of shafts 12. Each shaft may be a different color and/or style. Accordingly, on a first day, the user may attach a black colored shaft 12 to the handle 14, and on a second day, the user may attach a red colored shaft 12 to the handle 14. As such, the walking cane 10 discussed above may have only one handle 14 and the plurality of shafts 12 (i.e., space saver), yet the walking cane 10 may be stylistically versatile in the sense that a greater variety of styles or colors may be created with the walking cane 10 discussed above compared to prior art walking canes with handles fixed to the shafts.

The shaft 12 may define a ferrule end portion 60 and a handle end portion 58. The ferrule end portion 60 may be spring loaded so as to provide an impact cushion to the user of the cane 10. For example, the ferrule end portion 60 may have a circular prong which engages to a corresponding aperture formed within the shaft 12. The corresponding aperture may be formed within a distal end of the shaft 12 opposite from the handle end portion 58. A spring may be inserted into the corresponding aperture. The spring may have an appropriate stiffness such that when the cane 10 is in use, the spring may bear the brunt of the impact force between the ferrule end portion 60 and the ground. Hence, the impact force to the user's hand, elbows, and shoulders during each step of the user is reduced.

The handle 14 and the shaft 12 may be fabricated from similar or different materials. By way of example and not limitation, the handle 14 and/or shaft 12 may be fabricated from a material such as composite material, fiber composite material, carbon fiber composite material, aluminum, metal, aluminum, plastic, combinations thereof, and the like. Preferably, the handle 14 is fabricated to be heavier compared to the shaft 12 to allow the user to easily position the ferule end portion 60 of the shaft for the next stride of the user. The handle 14, and more particularly, the inner surface 54 of the collar 50 may be fabricated from a material that has a hardness greater than the shaft 12, and more particularly, the handle end portion 58. In this regard, as the handle end portion 58 is repetitively removed from and engaged to the inner surface 54, the shaft 12 may wear down prior to the inner surface 54 of the handle 14 wearing down. Furthermore, to further obtain a lightweight cane 10, the shaft 12 may have a hollow interior.

The ergonomic features (e.g., curvature of the upper surface and contact surface, indentation on the bottom surface, grooves and round indentations, light weight shaft, etc . . . ) have been incorporated into a walking cane that is additionally aesthetically attractive in that the handle may be fabricated to resemble a lady bug and the walking cane may be transformed between being appropriate for a formal occasion as well as for a fun time occasion. Simply put, the walking cane 10 of the present invention addresses the needs identified in the background of the invention.

This description of the various embodiments of the present invention is presented to illustrate the preferred embodiments of the present invention, and other inventive concepts may be otherwise variously embodied and employed. The appended claims are intended to be construed between such variations except insofar a limited by prior art.

1. A method for detecting a high pressure condition within an interrupter, comprising:
measuring an intensity of at least a portion of light emitted from an arc created by contacts within said interrupter;
comparing said measured intensity with a predetermined value; and
providing a first indication when said measured intensity exceeds said predetermined value.

2. A method for detecting a high pressure condition within an interrupter as recited in claim 1, further comprising:
measuring a duration of said arc;
comparing said measured duration with predetermined time period; and,
providing a second indication when said measured duration exceeds said predetermined time period.

3. A method for detecting a high pressure condition within an interrupter as recited in claim 1, wherein said measured intensity is determined by a photo detector.

4. A method for detecting a high pressure condition within an interrupter as recited in claim 3, wherein said at least a portion of light emitted from said arc is directed to said photo detector by a fiber optic cable.

5. A method for detecting a high pressure condition within an interrupter, comprising:
transmitting a beam of light through a window placed within an exterior wall of said interrupter;
reflecting said beam of light off a reflective surface, said reflective surface residing within the interior volume of said interrupter;
measuring an intensity of at least a portion of the reflected beam of light;
comparing said measured intensity with a predetermined value; and
providing an indication when said measured intensity is less than said predetermined value.

6. A method for detecting a high pressure condition within an interrupter as recited in claim 5, wherein said beam of light is transmitted to said window by a fiber optic cable.

7. A method for detecting a high pressure condition within an interrupter as recited in claim 5, wherein said reflected beam of light is transmitted to a measuring device by a fiber optic cable.

8. A method for detecting a high pressure condition within an interrupter as recited in claim 7, wherein said measuring device comprises a photo detector.

9. A method for detecting a high pressure condition within an interrupter, comprising:
placing a diaphragm within an outer wall of said interrupter, wherein said diaphragm is in a collapsed position for internal pressures below a first predetermined value, and said diaphragm is in an expanded condition for internal pressures above a second predetermined value;
directing a beam of light at an outer surface of said diaphragm;
detecting a reflected beam of light from said outer surface when said diaphragm is in said collapsed position;
producing a non-detectable reflected beam of light when said outer surface of said diaphragm is in the expanded position; and,
producing a high pressure indication when said beam of light is no longer detected.

10. A method for detecting a high pressure condition within an interrupter as recited in claim 9, wherein said beam of light is directed to said outer surface with a fiber optic cable.

11. A method for detecting a high pressure condition within an interrupter as recited in claim 9, wherein said reflected beam of light is transmitted to a detection device with a fiber optic cable.

12. A method for detecting a high pressure condition within an interrupter as recited in claim 9, wherein said first predetermined value is between 2 and 7 psia.

13. A method for detecting a high pressure condition within an interrupter as recited in claim 9, wherein said second predetermined value is between 2 and 7 psia.

14. A method for detecting a high pressure condition within an interrupter, comprising:
placing a diaphragm within an outer wall of said interrupter, wherein said diaphragm is in a collapsed position for internal pressures below a first predetermined value, and said diaphragm is in an expanded position for internal pressures above a second predetermined value;
directing a beam of light at an outer surface of said diaphragm;
detecting a reflected beam of light from said outer surface when said diaphragm is in said expanded position;
producing a non-detectable reflected beam of light when said outer surface of said diaphragm is in the collapsed position; and,
producing a high pressure indication when said beam of light is detected.

15. A method for detecting a high pressure condition within an interrupter as recited in claim 14, wherein said beam of light is directed to said outer surface with a fiber optic cable.

16. A method for detecting a high pressure condition within an interrupter as recited in claim 14, wherein said reflected beam of light is transmitted to a detection device with a fiber optic cable.

17. A method for detecting a high pressure condition within an interrupter as recited in claim 14, wherein said first predetermined value is between 2 and 7 psia.

18. A method for detecting a high pressure condition within an interrupter as recited in claim 14, wherein said second predetermined value is between 2 and 7 psia.

19. A method for detecting a high pressure condition within an interrupter, comprising:
placing a pressure transducer within an enclosed volume of said interrupter;
placing a window within an external wall of said interrupter;
converting pressure measurements made by said pressure transducer to an optical signal; and,
directing said optical signal through said window.

20. A method for detecting a high pressure condition within an interrupter as recited in claim 19, wherein said optical signal is transmitted to a receiving device by a fiber optic cable.

21. A method for detecting a high pressure condition within an interrupter as recited in claim 20, wherein said receiving device comprises a photo detector.

22. A method for detecting a high pressure condition within an interrupter as recited in claim 19, wherein said pressure transducer is powered by magnetic fields within said interrupter.

23. A method for detecting a high pressure condition within an interrupter, comprising:
placing a pressure transducer within an enclosed volume of said interrupter;
converting pressure measurements made by said pressure transducer to an RF signal; and, transmitting said RF signal to a receiver located outside said interrupter.

24. A method for detecting a high pressure condition within an interrupter as recited in claim 23, wherein said pressure transducer is powered by magnetic fields within and surrounding said interrupter.

25. An apparatus for detecting high pressure within an interrupter, comprising:
a cylinder having a piston, a first volume, and a second volume,
said piston dividing said first volume from said second volume,
said first volume fluidically coupled to an interior volume of said interrupter;
a shaft, attached to said piston and extending out of said cylinder; and,
a means for detecting a position of said shaft.

26. An apparatus for detecting high pressure within an interrupter, comprising:
a collapsible device, enclosed within said interrupter, having a first surface and a second surface, said first surface fixed relative to said interrupter, said second surface movable relative to said first surface with an increase in pressure within said interrupter;
a shaft, having a first end and a second end, said first end attached to said second surface of said collapsible device; and,
a means for detecting a position of said second end of said shaft.
